(19) United States
(12) Patent Application Publication
(10) Pub. No.: US 2010/0206786 A1
(43) Pub. Date: Aug. 19, 2010

(54) SOLID SEPARATION SYSTEM

(76) Inventors: Mii FUKUDA, Tokyo (JP); Takashi MENJU, Kawasaki-shi (JP); Yasushi YAMAMOTO, Yokohama-shi (JP); Tokusuke HAYAMI, Tokyo (JP); Taizo UCHIMURA, Yokohama-shi (JP); Kazuyoshi AOKI, Yokohama-shi (JP); Ichiro YAMANASHI, Tokyo (JP); Kazuhiko NODA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/706,615

(22) Filed: Feb. 16, 2010

(30) Foreign Application Priority Data
Feb. 17, 2009 (JP) P2009-033609
Oct. 15, 2009 (JP) P2009-238694

(51) Int. Cl. C02F 1/52; B01D 21/01; C02F 1/66; B01D 21/34

(52) U.S. Cl. 210/88; 210/202

(57) ABSTRACT

An aggregating agent injector (12) employs water currents generated by a raw water pump (10) to have flowing raw water undergo injection of an aggregating agent for aggregation of solids in raw water to form flocs, a first stirrer (13) works, as raw water inflows with the aggregating agent injected therein, for use of water currents thereof to stir inflowing raw water, and cause to outflow, a flocculation vessel (14) works, as stirred raw water inflows, to have inflowing raw water reside therein to form flocs, and cause to outflow, by using water currents thereof, and a centrifugal separator (15) works, as raw water inflows with flocs therein, for use of water currents thereof to have inflowing raw water swirl, effecting centrifugal separation thereof into flocs as solids and processed water.

### CROSS REFERENCE TO RELATED APPLICATIONS

The present application claims the benefit of priority under 35 U.S.C. §119 to Japanese Patent Application No. 2009-033609, filed on Feb. 17, 2009 and Japanese Patent Application No. 2009-238694, filed on Oct. 15, 2009 the entire contents of which are incorporated herein by reference.

### BACKGROUND OF THE INVENTION

1. Field of Art

The present invention relates to a solid separation system for separating solids from solid-suspending raw water in a water treatment such as an effluent treatment or water purification.

2. Description of Relevant Art

Generally, the water treatment has a process of separating solids such as suspended matters or turbid materials, whereto as illustrated in FIG. 1 mostly employed is a solid separation system 1 including a combination of a flocculation using a flocculating agent and a flocculation aid, and a separation by sedimentation in a gravity settling vessel.

Referring to FIG. 1, the solid separation system 1 has raw water inflow as a target to be processed, which is sent by a raw water pump 100 to an admixing vessel 101. At the admixing vessel 101, inflowing raw water is admixed by an admixer 102 with a flocculating agent injected by a flocculating agent injector 103. Raw water as an admixture with the flocculating agent at the admixing vessel 101 is sent to a reaction vessel 104. At the reaction vessel 104, inflowing raw water is caused by a mixer 105 to mix with a flocculation aid injected by a flocculation aid injector 106. Raw water as a mixture with the flocculation aid at the reaction vessel 104 is sent to a flocculating vessel 107. The flocculating vessel 107 has a flocculator 108 configured to promote flocculation of inflowing raw water, for growth of flocs. At the flocculating vessel 107, flocs are formed as suspensions in raw water, which is sent to a gravity settling vessel 109. At the gravity settling vessel 109, inflowing raw water resides therein for a prescribed time interval or more, where due to differences in specific gravity between water and flocs, those flocs of solids having greater specific gravities are caused to settle down, so flocs are separated from water. In the solid separation system 1, after the floc settling, there appears clear supernatant liquid to be taken as processed water.

That is, in systems making use of a gravity settling, there has been the need of causing raw water to reside within a gravity settling vessel 109, for a necessary time interval to settle down flocs. The gravity settling vessel 109 thus has needed a large capacity. To this point, the gravity settling vessel 109 could use an inclined plate or inclined channels for enhancement in efficiency of separation, to implement an enhanced processing rate with a reduced capacity, subject to limitations to, among others, reduction in capacity of gravity settling vessel 109 and enhancement of processing rate.

As an effective solution to such issues that the use of gravity settling encountered in capacity reduction of a gravity settling vessel and enhancement of the processing rate, there have been centrifugal separators including a liquid cyclone, refer to Japanese Patent Application Laid-Open Publication No. 2004-313900. The liquid cyclone is configured to cause inflowing raw water with suspended sandy particles to whirl in spin, making use of centrifugal forces to separate from raw water those sandy particles equal to or greater than a prescribed particle diameter. Such the liquid cyclone has been adapted for use of centrifugal forces greater in acceleration than the gravity, to separate sandy particles as solids within a shorter period than use of the gravity, permitting provision of a smaller reduced capacity of liquid cyclone than a reduced capacity of gravity settling vessel.

However, the liquid cyclone, in which raw water is caused to swirl at a high speed, has been inadaptable for separation of such lumps of substances as tending to be torn in bits with swirling flows, like flocs that have small binding forces. As a result, in order to separate from raw water easily tearable substances such as flocs, there has been unavoidable use of a gravity settling vessel with a prolonged processing rate and a large capacity.

It is an object of the present invention to provide a solid separation system allowing for an enhanced efficiency of separation with a reduced processing time and a saved installation space.

### SUMMARY OF THE INVENTION

According to an aspect of the present invention, there is a solid separation system wherein raw water including solids inflows through a raw water pump and whereby raw water is separated into solids and processed water, the solid separation system comprising an aggregating agent injector configured for use of water currents the raw water pump has generated, to have flowing raw water undergo injection of an aggregating agent adapted for aggregation of solids in raw water to form flocs, a first stirrer configured to work, as raw water inflows with the aggregating agent injected therein, for use of water currents thereof to stir inflowing raw water, and cause to outflow, a flocculation vessel configured to work, as stirred raw water inflows, to have inflowing raw water reside therein to form flocs, and cause to outflow, by using water currents thereof, and a centrifugal separator configured to work, as raw water inflows with flocs therein, for use of water currents thereof to have inflowing raw water swirl, effecting centrifugal separation thereof into flocs as solids and processed water.

### BRIEF DESCRIPTION OF THE DRAWINGS

FIG. 1 is a diagram of a typical solid separation system.

FIG. 2 is a diagram of a solid separation system according to a first embodiment.

FIG. 3 is a diagram of a solid separation system according to a second embodiment.

FIG. 4 is a diagram of a solid separation system according to a third embodiment.

FIG. 5 is a diagram of a solid separation system according to a fourth embodiment.

FIG. 6 is a diagram of a solid separation system according to a fifth embodiment.

FIG. 7 is a diagram of a solid separation system according to a sixth embodiment.

FIG. 8 is a diagram of a solid separation system according to a seventh embodiment.

FIG. 9 is a diagram of a solid separation system according to an eighth embodiment.

FIG. 10 is a diagram of a solid separation system according to a ninth embodiment.

FIG. 11 is a diagram of a solid separation system according to a tenth embodiment.

FIG. 12 is a diagram of a solid separation system according to an eleventh embodiment.

FIG. 13 is a diagram of a solid separation system according to a twelfth embodiment.

### DETAILED DESCRIPTION OF THE EMBODIMENTS

There will be described a respective one of solid separation systems according to embodiments of the present invention with reference to the drawings. According to the present invention, the solid separation system is implemented as equipment for a water treatment, such as an effluent treatment or water purification, in which raw water that includes solids such as suspended matters or turbid materials is separated into liquid and solids, like the conventional solid separation system 1 described above with reference to FIG. 1. Like elements are designated by like reference characters, for description with eliminated redundancy.

### First Embodiment

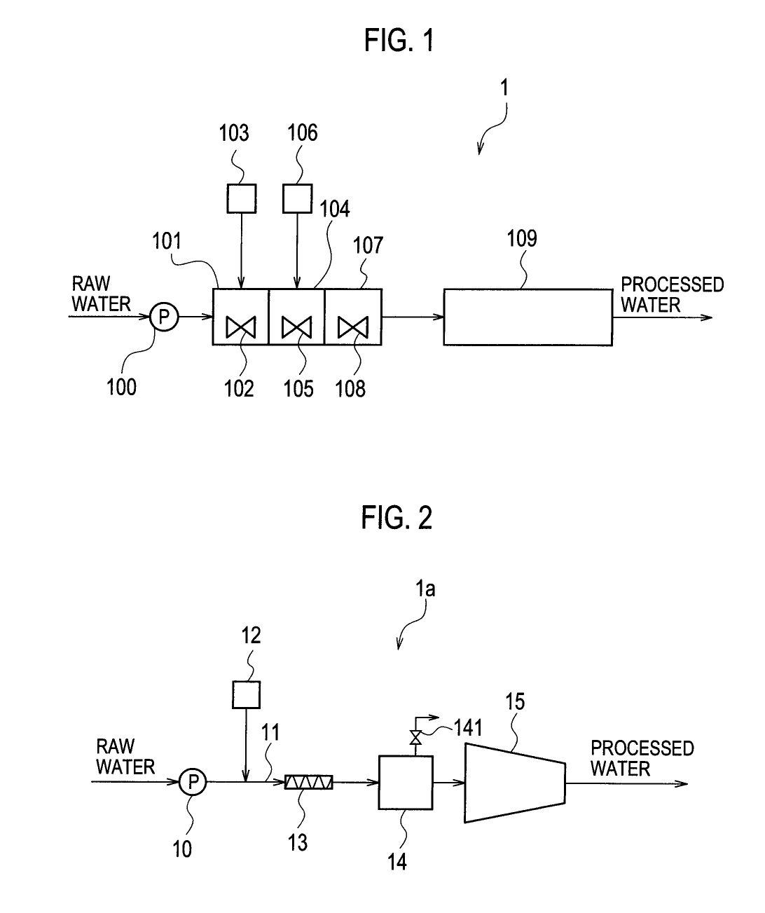

Referring to FIG. 2, according to a first embodiment of the present invention, a solid separation system 1a includes: a raw water pump 10 configured to introduce raw water as a target to be processed; an aggregating agent injector 12 configured to inject an aggregating agent into raw water flowing along a water line 11; a stirrer 13 configured to stir raw water with the aggregating agent injected therein on the water line 11; a flocculation vessel 14 configured to work, as stirred raw water inflows with the aggregating agent therein, to have the aggregating agent cause solids suspended in raw water to grow into flocs; and a centrifugal separator 15 configured to work, as raw water inflows with grown flocs suspended therein, to separate therefrom flocs as solids.

The raw water pump 10 is adapted to deliver sufficient water currents to send raw water introduced into the solid separation system 1a, to the centrifugal separator 15.

The aggregating agent injector 12 is configured to inject, into a flow of raw water in the water line 11, an aggregating agent adapted to clamp together suspended solids in raw water. The aggregating agent injector 12 is adapted for injection by a controlled dose of an adequate kind of aggregating agent selective from among inorganic flocculating agents, such as poly aluminum chloride, alum or aluminum sulfate, ferric chloride, and poly iron sulfate, in accordance with a system of suspended solids in raw water.

The stirrer 13 is configured as equipment to be installed on the water line 11, like a line mixer, to stir raw water with the aggregating agent by simply using water currents, without needing extra power else. At the stirrer 13, raw water undergoes a stir together with the aggregating agent, which provides flocs with increased tendencies to grow in the flocculation vessel 14.

After the stir with aggregating agent at the stirrer 13, raw water inflows to the flocculation vessel 14, where it runs, taking a residence time, during which suspended solids in raw water clump together, forming flocs. The flocculation vessel 14 has a sealed structure, where raw water having flocs formed therein is displaced, by raw water being forced to inflow anew by water currents the raw water pump 10 has delivered, to send to the centrifugal separator 15.

At the flocculation vessel 14, inflowing raw water may contain soluble gases that might have intruded in the course of supplying an aggregating agent. The flocculation vessel 14 of a sealed structure would cause those gases having intruded as part of raw water to remain therein, reducing the efficiency of flocculation, if it has no vent systems. To this point, preferably, the flocculation vessel 14 should have a gas venting mechanism 141 for venting residual gases, in combination with a scum skimming mechanism for removal of scum. The provision of a gas vent mechanism 141 combined with a scam skimming mechanism effectively prevents residence of gases and scum in the flocculation vessel 14.

The centrifugal separator 15 is configured to make inflowing raw water whirl in spin therein, having developed centrifugal forces acting on flocs as accelerations greater than the gravity, thereby spinning down flocs at enhanced settling rates, for separation of raw water into flocs as solids and processed water.

According to the first embodiment, the solid separation system 1a has a stirrer 13 installed on the water line 11 through which raw water is sent from the raw water pump 10 to the flocculation vessel 14, unlike the conventional solid separation system needing an admixer. Moreover, the solid separation system 1a has, in place of a gravity settling vessel needed in the conventional solid separation system, a centrifugal separator 15 adapted for use of centrifugal forces to spin down solids and sized to be smaller than the gravity settling vessel. Accordingly, the solid separation system 1a allows for provision of a compact simplified solid separation system with a reduced installation space.

Further, in the solid separation system 1a, the centrifugal separator 15 is configured to produce swirling flows for use of centrifugal forces combined with the gravity to settle down flocs. Accordingly, the solid separation system 1a permits flocs to be settled down within shorter periods than the conventional solid separation system using the gravity only, and allows for an enhanced efficiency of separation.

Still more, in the solid separation system 1a, the raw water pump 10 is adapted to send raw water by itself all the way to the centrifugal separator 15, permitting the stirrer 13 and the centrifugal separator 15 to work for stir and separation, respectively, simply with power of water currents. Accordingly, the solid separation system 1a requires no extra drive than the raw water pump 10, and enables implementation of low energy. That is, the solid separation system 1a allows for an implemented low energy, unlike the conventional solid separation system 1 including an admixer 102, a mixer 105, a flocculator 108, and a gravity settling vessel 109 with unshown measures for collection of floc sediment, to be each operated by a drive.

### Second Embodiment

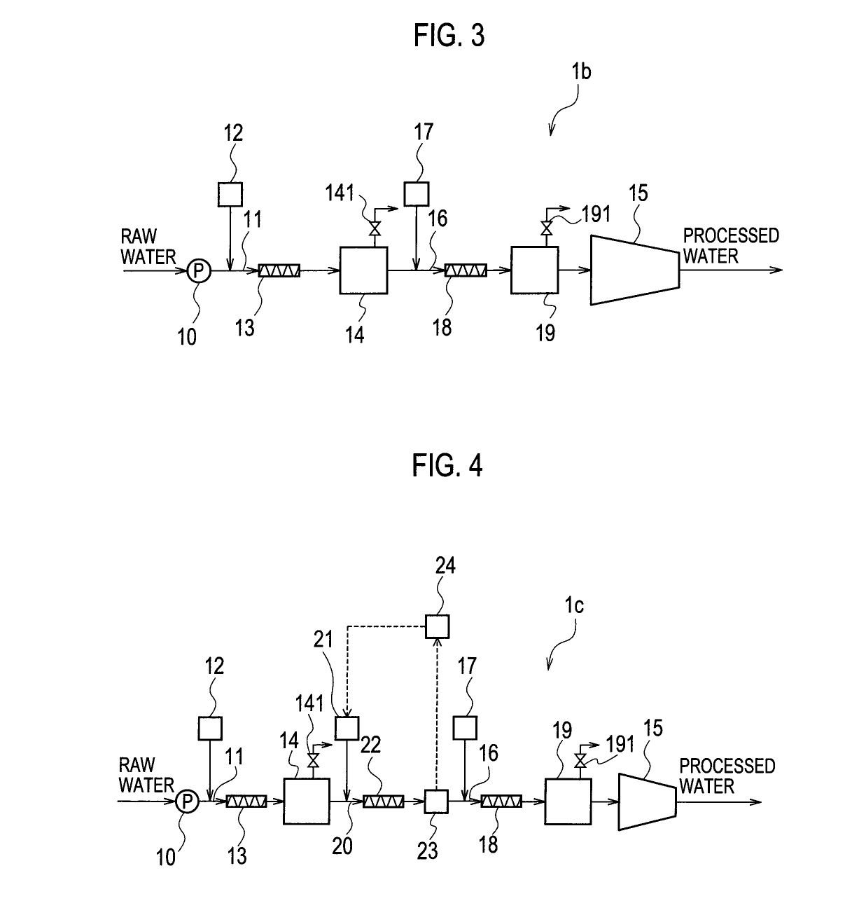

Referring to FIG. 3, according to a second embodiment of the present invention, there is a solid separation system 1b different from the solid separation system 1a according to the first embodiment described with reference to FIG. 2, in that it includes a subsystem comprised of a second water line 16, an aggregation aid injector 17, a second stirrer 18, and a second flocculation vessel 19, in addition to that system including a water line (referred herein to as a first water line) 11, an aggregating agent injector 12, a stirrer (referred herein to as a first stirrer) 13, and a flocculation vessel (referred herein to as a first flocculation vessel) 14.

As shown in FIG. 3, in the solid separation system 1b, raw water is not directly sent from the first flocculation vessel 14 to a centrifugal separator 15, but is sent via the second water line 16 to the second flocculation vessel 19.

The aggregation aid injector 17 is configured to inject, into raw water flowing along the second water line 16, an aggregation aid adapted to harden or enlarge flocs being formed by an aggregating agent. The aggregation aid injector 17 is adapted for injection by a controlled dose of an adequate kind of aggregation aid selective from among organic high-molecular flocculating agents such as polyacrylamide and inorganic high-molecular flocculating agents such as poly silica, in accordance with a system of suspended solids in raw water.

At the centrifugal separator 15, if incoming flocs are soft with small binding forces, then they are cut by shearing forces produced by water currents of raw water, into fine pieces difficult to collect. Further, at the centrifugal separator 15, if incoming flocs are small in particle diameters, then centrifugal forces render collection of flocs difficult. Therefore, the aggregation aid injector 17 injects the aggregation aid adapted to harden or enlarge flocs, thereby providing flocs with increased tendencies for facile collection, allowing for an enhanced efficiency in collection of solids in raw water.

The second stirrer 18 is configured as equipment to be installed on the second water line 16, like a line mixer, to stir raw water with the aggregation aid by simply using water currents, without needing extra power else. At the second stirrer 18, raw water undergoes a stir together with the aggregation aid, which provides flocs with increased tendencies to be shaped for facile collection in the second flocculation vessel 19.

After the stir with aggregation aid at the second stirrer 18, raw water inflows to the second flocculation vessel 19, where it runs, taking a residence time, during which suspended solids in raw water are caused to grow with increased tendencies for facile collection of flocs, as an effect of the aggregation aid. Like the first flocculation vessel 14, the second flocculation vessel 18 has a sealed structure, and preferably, should have a gas venting mechanism 191 combined with a scum skimming mechanism for removal of scum, to prevent residence of gases and scum.

According to the second embodiment, the solid separation system 1b has an aggregation aid injector 17 configured for injection of an aggregation aid to have flocs formed with increased tendencies for facile collection at the centrifugal separator 15. Accordingly, the solid separation system 1b permits a facilitated collection of flocs at the centrifugal separator 15, thus allowing for an enhanced efficiency in collection of solids.

Further, according to the second embodiment, the solid separation system 1b allows for implementation of a simplified system with a saved energy and a saved space, like the solid separation system 1a according to the first embodiment.

In the example of FIG. 3, the solid separation system 1b includes the first flocculation vessel 14 and the second flocculation vessel 19. It however is noted that the first flocculation vessel 14 may well be eliminated to simply provide a second flocculation vessel 19. For such the simple provision of a second flocculation vessel 19, the second flocculation vessel 19 may have an increased capacity to extend the residence time in the second flocculation vessel 19, to achieve the same effect as the configuration including the first flocculation vessel 14.

### Third Embodiment

Referring to FIG. 4, according to a third embodiment of the present invention, there is a solid separation system 1c different from the solid separation system 1b according to the second embodiment described with reference to FIG. 3, in that it further includes a subsystem comprised of a third water line 20, an adjuster injector 21, a third stirrer 22, a pH meter 23, and a pH controller 24.

As shown in FIG. 4, in the solid separation system 1c, raw water flowing out of a first flocculation vessel 14 is sent to a second flocculation vessel 19, via the second water line 16 where its pH is measured by the pH meter 23.

The adjuster injector 21 in configured to inject, into raw water having flown out of the first flocculation vessel 14 and flowing along the third water line 20, an adjuster adapted to adjust the pH of raw water for enhancement of the flocculation effect of an aggregating agent. The adjuster injected by the adjuster injector 21 may be an adjuster (as a pH adjuster) of acid (hydrochloric acid, sulfuric acid, citric acid, etc) or alkali (sodium hydroxide solution, calcium hydroxide solution, etc).

The third stirrer 22 is configured as equipment to be installed on the third water line 20, like a line mixer, to stir raw water with the adjuster. At the third stirrer 22, raw water undergoes a stir together with the adjuster, which makes raw water homogeneous in pH, and provides flocs with increased tendencies to be shaped for facile collection in the second flocculation vessel 19.

The pH meter 23 is configured as a pH sensor to measure a pH of raw water after injection of adjuster by the adjuster injector 21.

The pH controller 24 is configured to store therein a target pH input as a set value, and work, as a measure of pH by the pH meter 23 is input, for comparison between the target pH and the measure of pH to control the adjuster injector 21 to inject, into raw water, a dose of adjuster depending on a difference in between. In other words, the pH controller 24 is adapted for a feedback control of the adjuster injector 21 in accordance with a measure of pH by the pH meter 23.

According to the third embodiment, the solid separation system 1c has an adjuster injector 21 configured for injection of an adjuster into raw water, to adjust raw water to an adequate pH for flocculation. Accordingly, the solid separation system 1c permits an enhanced flocculation, allowing for an enhanced efficiency of separation.

Further, according to the third embodiment, the solid separation system 1c has a pH controller 24 adapted for a feedback control of the adjuster injector 21 in accordance with a measure of pH by the pH meter 23. Accordingly, the solid separation system 1c can prevent over- or under-injection of adjuster, permitting an adequate dose of adjuster to be injected, allowing for an enhanced efficiency of separation.

Still more, according to the third embodiment, the solid separation system 1c allows for implementation of a simplified system with a saved energy and a saved space, like the solid separation system 1b according to the second embodiment.

In the example of FIG. 4, the solid separation system 1c includes the pH meter 23 and the pH controller 24. It however is noted that for situations of solid separation system 1c free of variations in injection rate of aggregating agent or pH of raw water to be processed, the provision of a combination of pH meter 23 and pH controller 24 may be substituted by control of the adjuster injector 21 to always inject a constant dose of adjuster.

Moreover, in the example of FIG. 4, the adjuster injector 21 undergoes a feedback control depending on a measure of pH of raw water after injection of an adjuster. It however is noted that the adjuster injector 21 may well undergo a feed-forward control depending on a measure of pH of raw water before injection of the adjuster.

Further, in the example of FIG. 4, the solid separation system 1c includes the first flocculation vessel 14 and the second flocculation vessel 19. It however is noted that the first flocculation vessel 14 may well be eliminated to simply provide a second flocculation vessel 19. For such the simple provision of a second flocculation vessel 19, the second flocculation vessel 19 may have an increased capacity to extend the residence time in the second flocculation vessel 19, to achieve the same effect as the configuration including the first flocculation vessel 14.

### Fourth Embodiment

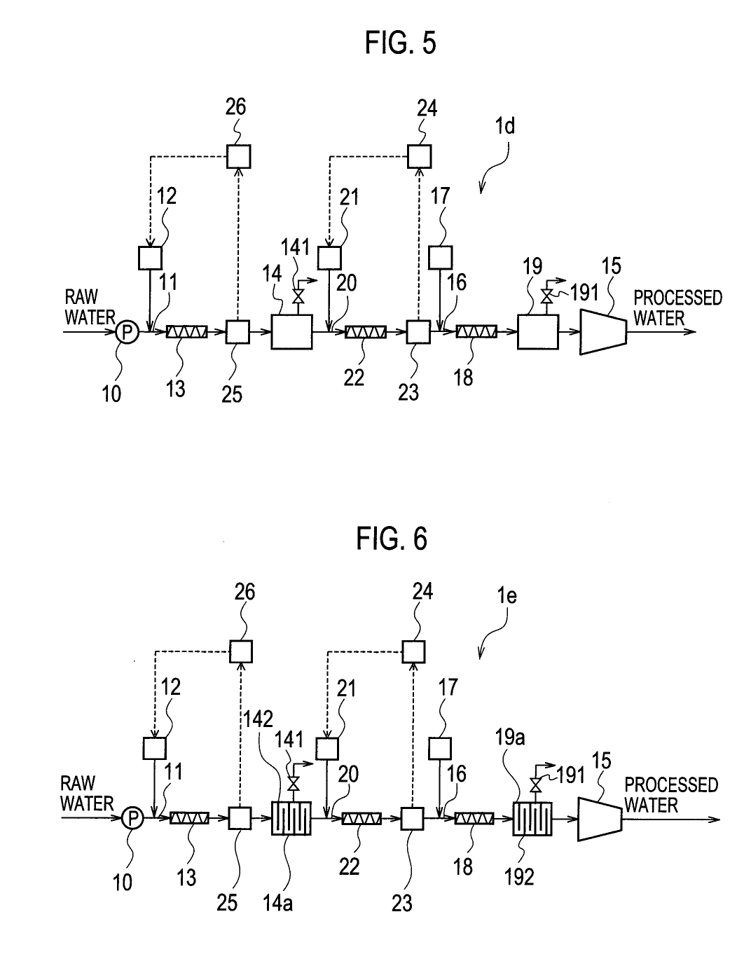

Referring to FIG. 5, according to a fourth embodiment of the present invention, there is a solid separation system 1d different from the solid separation system 1c according to the third embodiment described with reference to FIG. 4, in that it further includes a combination of a streaming current meter 25 and an aggregating agent controller 26.

The streaming current meter 25 is configured as a measuring instrument to measure a streaming current of raw water after injection of an aggregating agent by an aggregating agent injector 12.

The aggregating agent controller 26 is configured to work, as a measure of streaming current of raw water by the streaming current meter 25 is input, to control the aggregating agent injector 12 to inject, into raw water, a dose of aggregating agent in accordance with the measure of streaming current. That is, the aggregating agent controller 26 is adapted for use of a measure by the streaming current meter 25 to implement a feedback control of the aggregating agent injector 12. For instance, the aggregating agent controller 26 may be adapted to store therein an expression for determining an optimal dose of aggregating agent depending on a measure of streaming current of raw water, and control the aggregating agent injector 12 for injection of a dose of aggregating agent in correspondence to an input measure of streaming current.

According to the fourth embodiment, the solid separation system 1d has an aggregating agent controller 26 configured for a feedback control of the aggregating agent injector 12 in accordance with a measure of streaming current of raw water by the streaming current meter 25. Accordingly, the solid separation system 1d can prevent over- or under-injection of aggregating agent, permitting an adequate dose of aggregating agent to be injected, allowing for an enhanced efficiency of separation.

Further, according to the fourth embodiment, the solid separation system 1d allows for implementation of a simplified system with a saved energy and a saved space, like the solid separation system 1c according to the third embodiment.

It is noted that for situations not in need of pH adjustment of raw water to be processed, and of adjuster injection, the solid separation system 1d may well exclude an adjuster injector 21 and a third stirrer 22. Even in need of adjuster injection, if the situation is free of variations in injection rate of aggregating agent or pH of raw water, the solid separation system 1d may well exclude a combination of pH meter 23 and pH controller 24.

Moreover, in the example of FIG. 5, the aggregating agent injector 12 undergoes a feedback control depending on a measure of streaming current of raw water after injection of an aggregating agent. It however is noted that the aggregating agent injector 12 may well undergo a feed-forward control depending on a measure of streaming current of raw water before injection of the aggregating agent.

Further, in the example of FIG. 5, the solid separation system 1d includes a first flocculation vessel 14 and a second flocculation vessel 19. It however is noted that the first flocculation vessel 14 may well be eliminated to simply provide a second flocculation vessel 19. For such the simple provision of a second flocculation vessel 19, the second flocculation vessel 19 may have an increased capacity to extend the residence time in the second flocculation vessel 19, to achieve the same effect as the configuration including the first flocculation vessel 14.

### Fifth Embodiment

Referring to FIG. 6, according to a fifth embodiment of the present invention, there is a solid separation system 1e different from the solid separation system 1d according to the fourth embodiment described with reference to FIG. 5, in that it includes a combination of a first flocculation vessel 14a configured for a stirring function and a second flocculation vessel 19a likewise configured for a stirring function.

The first flocculation vessel 14a is configured with obstacles 142, such as baffles for instance, arranged therein to cause raw water inflowing from an inlet to flow horizontally or vertically around the obstacles 142, to go inside the vessel up to an outlet. In the first flocculation vessel 14a with obstacles 142 therein, raw water is caused to flow around moderately, while being stirred. Therefore, in the first flocculation vessel 14a, solids in raw water are promoted to collide with each other, growing to greater flocs than would be formed by due aggregation. The first flocculation vessel 14a thus permits growth to large flocs, simply by provision of internal obstacles 142 such as baffles, without needing any extra drive such as measures for stirring raw water in the vessel.

Likewise, the second flocculation vessel 19a is configured with obstacles 192, such as baffles for instance, arranged therein to cause raw water inflowing from an inlet to flow horizontally or vertically around the obstacles 192, to go inside the vessel up to an outlet. Also in the second flocculation vessel 19a, raw water flows around moderately, while being stirred, whereby solids in raw water are promoted to collide with each other, causing flocs to grow into greater flocs. The second flocculation vessel 19a also permits growth to large flocs, simply by provision of internal obstacles 192 such as baffles, without needing any extra drive such as measures for stirring raw water in the vessel.

For flocs to be grown large, preferably, raw water in the first flocculation vessel 14a should be stirred within a range of stirring intensities equal to or smaller than a first stirring intensity. Specifically, the first stirring intensity is about 90 (l/s). Within the range of stirring intensities equal to or smaller than the first stirring intensity, the first flocculation vessel 14a is adapted to have flocs grown with large diameters, though being still weak in hardness.

Further, for flocs grown in the first flocculation vessel 14a to be hardened in the second flocculation vessel 19a, preferably, raw water in the second flocculation vessel 19a should be stirred within a range of stirring intensities equal to or greater than a second stirring intensity. Specifically, the second stirring intensity is about 180 (l/s). Within the range of stirring intensities equal to or greater than the second stirring intensity, the second flocculation vessel 19a is adapted to have flocs hardened from their weak-hardness states.

The first and second flocculation vessels 14a and 19a are each adapted to have stirring intensities therein changed in dependence such as on shapes of, or the installation method or number of, obstacles 149 or 192 in the flocculation vessel 14a or 19a.

More specifically, there is a magnitude of stir GT determined by an expression (1), such that

$$GT = \sqrt{\frac{ρ ghT}{μ}} , \qquad ( 1 )$$

where G: stirring intensity (l/s),

ρ: density of water (kg/m³),

g: acceleration of gravity (m/s²),

h: loss of water head in flocculation vessel (m),

T: residence time in flocculation vessel (s), and

μ: viscosity coefficient of water (kg/ms).

The flocculation vessels 14a and 19a in which obstacles 142 and 192 are arranged to stir raw water tend to have sludge residing on obstacles 142 and 192 therein. Such residual sludge in the flocculation vessels 14a and 19a may cause flocs to become massive or flow paths of raw water to be blocked, resulting in a reduced efficiency of flocculation. To this point, preferably, the flocculation vessels 14a and 19a should have their backwashing mechanisms, besides their gas venting mechanisms 141 and 191 combined with scum skimming mechanisms. By provision of backwashing mechanisms, the flocculation vessels 14a and 19a may be adapted to prevent flocs from getting massive or flow paths from being blocked, permitting a prevented flow reduction of raw water.

As an example of backwashing, the flocculation vessel 14a or 19a may be operated to shift by changeover of flow path from a normal operation where flow is downstream, to a reverse operation where flow is upstream. For instance, the reverse operation may be a backwashing that the flocculation vessel 14a or 19a can do simply with a mechanism for reversing the flow of raw water, which permits entering the backwashing without stopping operation of the flocculation vessel 14a or 19a.

As another example of backwashing, the flocculation vessel 14a or 19a may have a closed washing loop adapted for water circulation for a washing. This method permits elimination of a tank for storage of washing water.

According to the fifth embodiment, the solid separation system 1e has flocculation vessels 14a and 19a each adapted to cause inflowing raw water to flow around, to thereby stir to have flocs grown large. Accordingly, the solid separation system 1e permits separation of large grown flocs, allowing for an enhanced efficiency of separation.

Further, according to the fifth embodiment, the solid separation system 1e allows for implementation of a simplified system with a saved energy and a saved space, like the solid separation system 1d according to the fourth embodiment.

It is noted that for some water quality (as measures of streaming current and pH) of raw water to be processed, the solid separation system 1e may well exclude any one of a combination of streaming current meter 25 and aggregating agent controller 26 and a subsystem including an adjuster injector 21, a third stirrer 22, a pH meter 23, and a pH controller 24.

Further, in the example of FIG. 6, the solid separation system 1e includes a first flocculation vessel 14a and a second flocculation vessel 19a. It however is noted that the first flocculation vessel 14a may well be eliminated to simply provide a second flocculation vessel 19a. For such the simple provision of a second flocculation vessel 19a, the second flocculation vessel 19a may have an increased capacity to extend the residence time in the second flocculation vessel 19a, to achieve the same effect as the configuration including the first flocculation vessel 14a.

### Sixth Embodiment

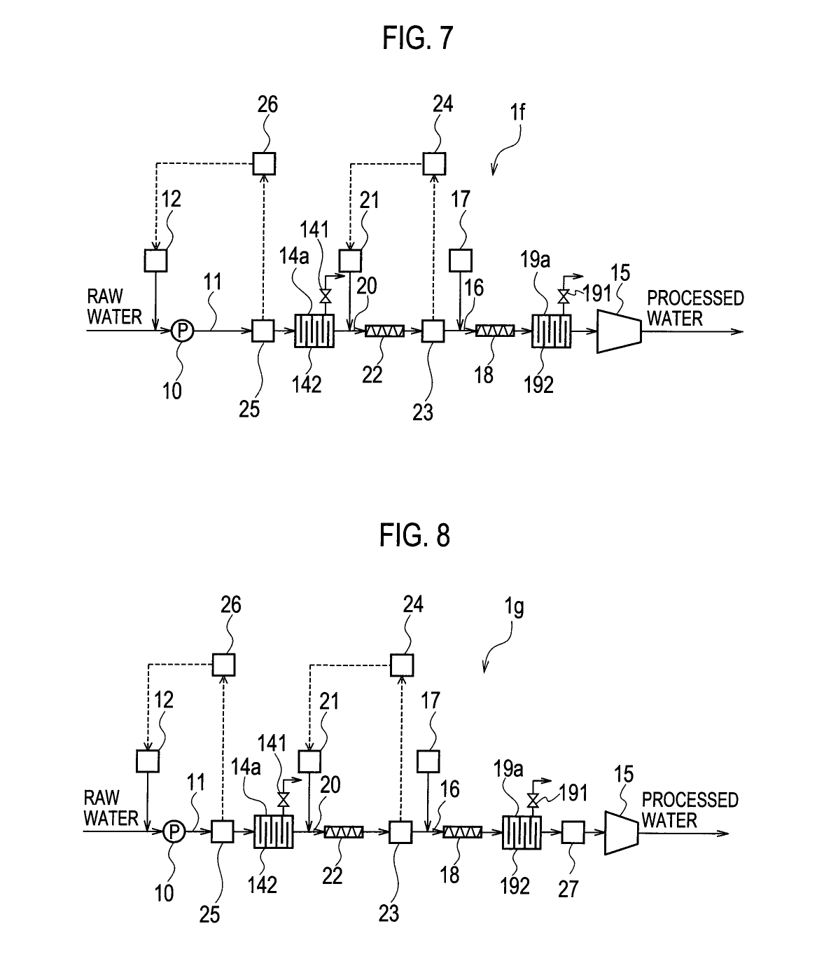

Referring to FIG. 7, according to a sixth embodiment of the present invention, there is a solid separation system if different from the solid separation system 1e according to the fifth embodiment described with reference to FIG. 6, in that it has excluded the first stirrer 13, and an aggregating agent is injected by a first aggregating agent injector 12 into raw water upstream a raw water pump 10.

The raw water pump 10 is configured to operate for sending raw water to flocculation vessels 14a and 19a, et seq, whereby raw water is stirred in the pump. The aggregating agent is injected into raw water upstream the raw water pump 10, and hence raw water is stirred together with the aggregating agent in the raw water pump 10, without the need of having the first stirrer 13 installed downstream the raw water pump 10. In this respect, preferably, the raw water pump 10 should be a type of pump in which vanes rotate, such as a vortex pump, in order for raw water to be sufficiently stirred therein.

According to the sixth embodiment, in the solid separation system 1f, the first stirrer 13 is not necessitated. Accordingly, the solid separation system if allows for the more simplified system configuration.

Further, according to the sixth embodiment, the solid separation system if affords to implement a saved energy and a saved space, allowing for an enhanced efficiency of separation, like the solid separation system 1e according to the fifth embodiment.

It is noted that for some water quality (as measures of streaming current and pH) of raw water to be processed, the solid separation system if may well exclude any one of a combination of streaming current meter 25 and aggregating agent controller 26 and a subsystem including an adjuster injector 21, a third stirrer 22, a pH meter 23, and a pH controller 24.

Further, in the example of FIG. 7, the solid separation system if includes a first flocculation vessel 14a and a second flocculation vessel 19a. It however is noted that the first flocculation vessel 14a may well be eliminated to simply provide a second flocculation vessel 19a. For such the simple provision of a second flocculation vessel 19a, the second flocculation vessel 19a may have an increased capacity to extend the residence time in the second flocculation vessel 19a, to achieve the same effect as the configuration including the first flocculation vessel 14a.

### Seventh Embodiment

Referring to FIG. 8, according to a seventh embodiment of the present invention, there is a solid separation system 1g different from the solid separation system if according to the sixth embodiment described with reference to FIG. 7, in that it includes a kneading mixer 27.

The kneading mixer 27 is configured as equipment for kneading flocs carried from flocculation vessels 14a and 19a where they have been formed, to deprive flocs of moisture to harden, and form flocs in spherical shapes. Flocs contain much moisture, and can be hardened by removing such moisture. Containing such moisture, flocs can be plastically deformed to harden by giving shocks. Using such shocks, the plastic deformation can be repeated plural times to have flocs come near spherical shapes.

According to the seventh embodiment, the solid separation system 1g is adapted to harden flocks, rendering spherical. Accordingly, the solid separation system 1g permits flocs to be cut into fine pieces in a centrifugal separator 15, allowing for an enhanced efficiency of separation.

Further, according to the seventh embodiment, the solid separation system 1g allows for implementation of a simplified system with a saved energy and a saved space, like the solid separation system if according to the sixth embodiment.

It is noted that for some water quality (as measures of streaming current and pH) of raw water to be processed, the solid separation system 1g may well exclude any one of a combination of streaming current meter 25 and aggregating agent controller 26 and a subsystem including an adjuster injector 21, a third stirrer 22, a pH meter 23, and a pH controller 24.

Further, in the example of FIG. 8, the solid separation system 1g includes a first flocculation vessel 14a and a second flocculation vessel 19a. It however is noted that the first flocculation vessel 14a may well be eliminated to simply provide a second flocculation vessel 19a. For such the simple provision of a second flocculation vessel 19a, the second flocculation vessel 19a may have an increased capacity to extend the residence time in the second flocculation vessel 19a, to achieve the same effect as the configuration including the first flocculation vessel 14a.

### Eighth Embodiment

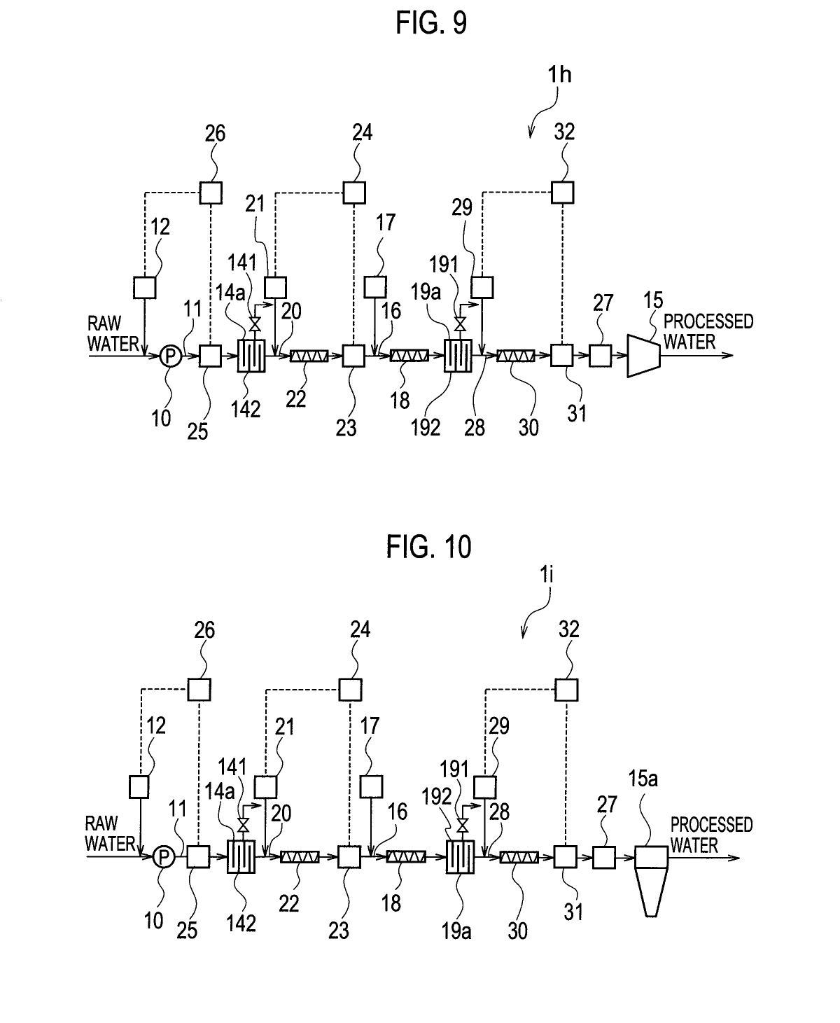

Referring to FIG. 9, according to an eighth embodiment of the present invention, there is a solid separation system 1h different from the solid separation system 1g according to the seventh embodiment described with reference to FIG. 8, in that it further includes a subsystem comprised of a fourth water line 28, a second adjuster injector 29, a fourth stirrer 30, a second pH meter 31, and a second pH controller 32, in addition to a subsystem including a third water line 20, an adjuster injector (referred herein to as a first adjuster injector) 21, a third stirrer 22, a pH meter (referred herein to as a first pH meter) 23, and a pH controller (referred herein to as a first pH controller) 24.

The second adjuster injector 29 in configured to inject, into raw water having flown out of the second flocculation vessel 19a and flowing along the fourth water line 28, an adjuster (as a pH adjuster) such as acid or alkali adapted to adjust the pH of raw water, to provide flocs with increased tendencies to be hardened. The adjuster injected by the adjuster injector 29 may be an adjuster (as a pH adjuster) of acid (hydrochloric acid, sulfuric acid, citric acid, etc) or alkali (sodium hydroxide solution, calcium hydroxide solution, etc).

The fourth stirrer 30 is configured as equipment to be installed on the fourth water line 28 like a line mixer, to stir raw water with the adjuster. At the fourth stirrer 30, raw water undergoes a stir together with the adjuster, which makes raw water homogeneous in pH, providing flocs with increased tendencies to be hardened.

The second pH meter 31 is configured as a pH sensor to measure a pH of raw water after injection of adjuster by the second adjuster injector 29.

The second pH controller 32 is configured to work, as a measure of pH by the second pH meter 31 is input, to control the second adjuster injector 29 to inject, into raw water, a dose of adjuster in accordance with the input measure of pH. In other words, the second pH controller 32 is adapted for a feedback control of the second adjuster injector 29 in accordance with a measure of pH by the second pH meter 31. For instance, the second pH controller 32 may be configured to store therein a target pH input as a set value, and work for comparison between the target pH and the measure of pH to control the second adjuster injector 29 to inject a dose of adjuster depending on a difference in between.

According to the eighth embodiment, the solid separation system 1h has a second adjuster injector 21 configured for injection of an adjuster into raw water, to adjust raw water to an adequate pH for kneading. Accordingly, the solid separation system 1h permits an enhanced kneading effect, allowing for an enhanced efficiency of separation.

Further, according to the eighth embodiment, the solid separation system 1h has the second pH controller 32 adapted for a feedback control of the second adjuster injector 29 in accordance with a measure of pH of raw water by the second pH meter 31. Accordingly, the solid separation system 1h can prevent over- or under-injection of adjuster, permitting an adequate dose of adjuster to be injected, allowing for an enhanced efficiency of separation.

Still more, according to the eighth embodiment, the solid separation system 1h affords to implement a simplified system, a saved energy, and a saved space, allowing for an enhanced efficiency of solid separation, like the solid separation system 1g according to the seventh embodiment.

In the example of FIG. 9, the solid separation system 1h includes the second pH meter 31 and the second pH controller 32. It however is noted that for situations of solid separation system 1h free of variations in injection rate of aggregating agent or pH of raw water to be processed, the provision of a combination of second pH meter 31 and second pH controller 32 may be substituted by control of the second adjuster injector 29 to always inject a constant dose of adjuster.

Moreover, in the example of FIG. 9, the second adjuster injector 29 undergoes a feedback control depending on a measure of pH of raw water after injection of an adjuster. It however is noted that the second adjuster injector 29 may well undergo a feed-forward control depending on a measure of pH of raw water before injection of the adjuster.

It is noted that for some water quality (as measures of streaming current and pH) of raw water to be processed, the solid separation system 1h may well exclude any one of a combination of streaming current meter 25 and aggregating agent controller 26 and a subsystem including a first adjuster injector 21, a third stirrer 22, a first pH meter 23, and a first pH controller 24.

Further, in the example of FIG. 9, the solid separation system 1h includes the first flocculation vessel 14a and the second flocculation vessel 19a. It however is noted that the first flocculation vessel 14a may well be eliminated to simply provide a second flocculation vessel 19a. For such the simple provision of a second flocculation vessel 19a, the second flocculation vessel 19a may have an increased capacity to extend the residence time in the second flocculation vessel 19a, to achieve the same effect as the configuration including the first flocculation vessel 14a.

### Ninth Embodiment

Referring to FIG. 10, according to a ninth embodiment of the present invention, there is a solid separation system 1i corresponding to a modification of the solid separation system 1h according to the eighth embodiment that has a centrifugal separator 15 (in FIG. 9), which comprises a liquid cyclone 15a (in FIG. 10).

The liquid cyclone 15a is configured as equipment to have raw water inflow in a tangential direction, to cause inflowing raw water to whirl in spin by energy of water currents, to separate solids from raw water.

It is noted that the centrifugal separator 15 may comprise else than the liquid cyclone 15a, and may be equipment configured to have raw water swirl inside, like a centrifugal thickener or centrifugal dehydrator, for use of centrifugal forces to separate solids from raw water.

According to the ninth embodiment also, the solid separation system 1i affords to implement a simplified system with a saved energy and a saved space, allowing for an enhanced efficiency of solid separation, like the solid separation system 1h according to the eighth embodiment.

### Tenth Embodiment

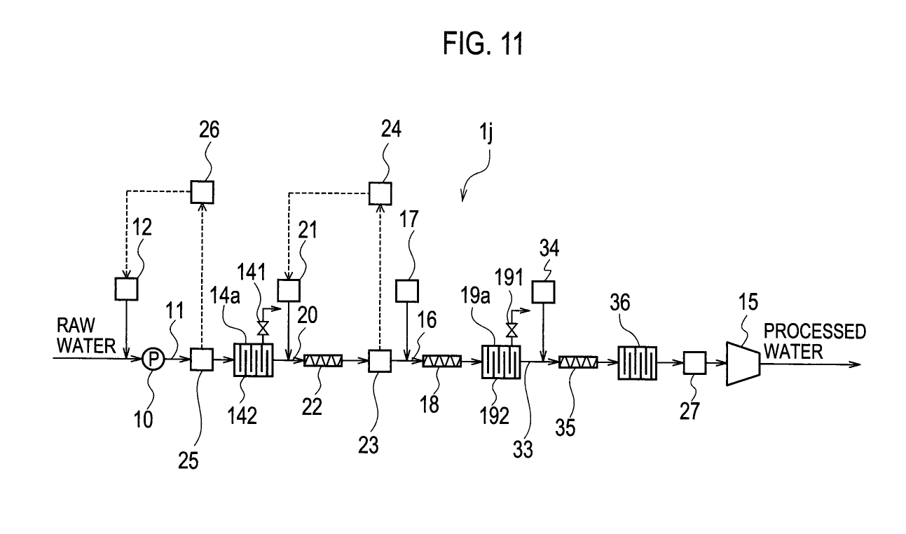

Referring to FIG. 11, according to a tenth embodiment of the present invention, there is a solid separation system 1j different from the solid separation system 1g according to the seventh embodiment described with reference to FIG. 8, in that it further includes a subsystem comprised of: a fifth water line 33 configured as a flow path for raw water flowing out of a second flocculation vessel 19a; a second aggregation aid injector 34 configured to inject an aggregation aid into raw water flowing along the fifth water line 33; a fifth stirrer 35 configured to stir raw water with the aggregation aid injected therein by the second aggregation aid injector 34; and a third flocculation vessel 36 configured to form flocs in raw water inflowing from the fifth water line 33. The solid separation system 1j has a kneading mixer 27 installed downstream the third flocculation vessel 36. It is noted that the third flocculation vessel 36 may also have a gas venting mechanism and a scum skimming mechanism.

There is a first aggregation aid injector 17 configured to inject an aggregation aid into raw water, which may or may not be identical to the aggregation aid to be injected by the second aggregation aid injector 34. The second aggregation aid injector 34 is adapted for injection by a controlled dose of an adequate kind of aggregation aid selective from among organic high-molecular flocculating agents and inorganic high-molecular flocculating agents, to still strengthen flocs in raw water from the second flocculation vessel 19a where they have been formed. Such the flow of aggregation aid injection and flocculation may be multi-staged to yet strengthen flocs, allowing for a facilitated collection.

According to the tenth embodiment, the solid separation system 1j is adapted inject an aggregation aid at a second aggregation aid injector 34, and form flocs at a third flocculation vessel 36. Accordingly, the solid separation system 1j permits the stronger flocs to be formed, allowing for an enhanced efficiency of separation.

Further, according to the tenth embodiment, the solid separation system 1j allows for implementation of a simplified system with a saved energy and a saved space, like the solid separation system 1g according to the seventh embodiment.

It is noted that for some water quality (as measures of streaming current and pH) of raw water to be processed, the solid separation system 1j may well exclude any one of a combination of streaming current meter 25 and aggregating agent controller 26 and a subsystem including an adjuster injector 21, a third stirrer 22, a pH meter 23, and a pH controller 24.

### Eleventh Embodiment

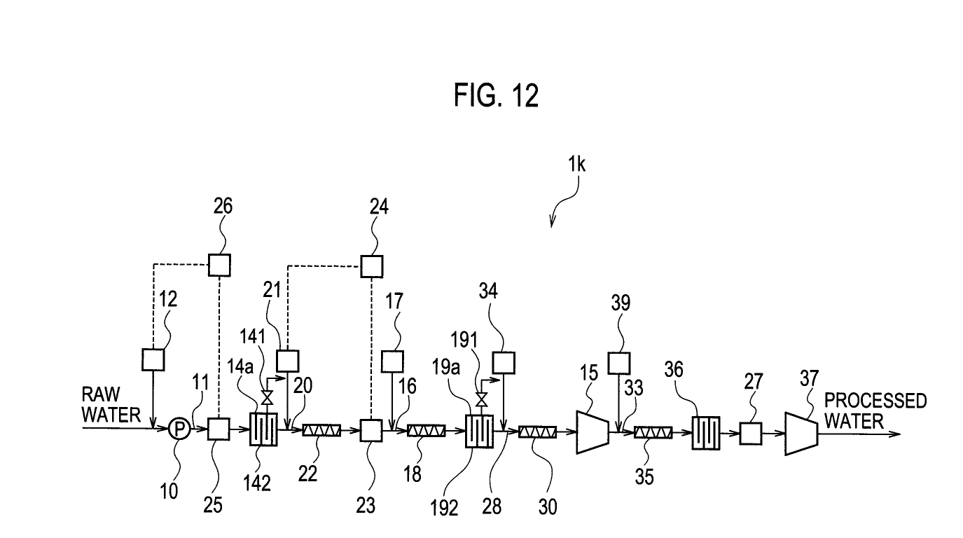

Referring to FIG. 12, according to an eleventh embodiment of the present invention, there is a solid separation system 1k different from the solid separation system 1j according to the tenth embodiment described with reference to FIG. 11, in that it has a subsystem including: a fifth water line 33 configured as a flow path for processed water flowing out of a centrifugal separator (referred herein to as a first centrifugal separator) 15 adapted for separation of flocs as solids from raw water that has undergone a stir by a fourth stirrer 30 following an injection of aggregation aid by a second aggregation aid injector 34; a third aggregation aid injector 39 configured to inject an aggregation aid into processed water flowing along the fifth water line 33; a fifth stirrer 35 configured to stir processed water with the aggregation aid injected therein by the third aggregation aid injector 39; a third flocculation vessel 36 configured to form flocs in processed water inflowing from the fifth water line 33; a kneading mixer 27 configured to knead processed water inflowing with flocs therein from the third flocculation vessel 36; and a second centrifugal separator 37 configured for separation of flocs from processed water having been knead with flocs therein in the kneading mixer 27 and inflowing therefrom, to have processed water outflow. It is noted that the third flocculation vessel 36 may also have a gas venting mechanism and a scum skimming mechanism.

Although the first centrifugal separator 15 serves to separate flocs that have been formed upstream, there may be inseparable solids left suspended in processed water flowing out of the first centrifugal separator 15. Inseparable solids may include flocs and the like torn by swirling water currents in the first centrifugal separator 15. Flocs may have weak molecular bonds, with tendencies to be torn by water currents. Therefore, downstream the first centrifugal separator 15, processed water that may have fragments of torn flocs suspended therein is again subjected to addition of an aggregation aid for forming strong flocs, and processed through a multi-staged flow of centrifugal separation, thereby permitting the collection rate of solids to be improved, with a resultant enhancement in quality of processed water.

It is noted that, upstream the aforesaid subsystem in the solid separation system 1k, there is a first aggregation aid injector 17 configured to inject an aggregation aid into raw water, which may or may not be identical to the aggregation aid injected by the second aggregation aid injector 34. The second aggregation aid injector 34 is adapted for injection by a controlled dose of an adequate kind of aggregation aid selective from among organic high-molecular flocculating agents and inorganic high-molecular flocculating agents, to still strengthen flocs in raw water from a second flocculation vessel 19a where they have been formed. Preferably, the aggregation aid injected by the third aggregation aid injector 39 should be identical to the aggregation aid injected by the second aggregation aid injector 34.

According to the eleventh embodiment, the solid separation system 1k is adapted to perform flocculation and centrifugal separation plural times, allowing for an enhanced quality of processed water.

According to the eleventh embodiment, the solid separation system 1k affords to implement a simplified system with a saved energy and a saved space, allowing for an enhanced efficiency of solid separation, like the solid separation system 1h according to the eighth embodiment.

It is noted that for some water quality (as measures of streaming current and pH) of raw water to be processed, the solid separation system 1k may well exclude any one of a combination of streaming current meter 25 and aggregating agent controller 26 and a subsystem including an adjuster injector 21, a third stirrer 22, a pH meter 23, and a pH controller 24.

### Twelfth Embodiment

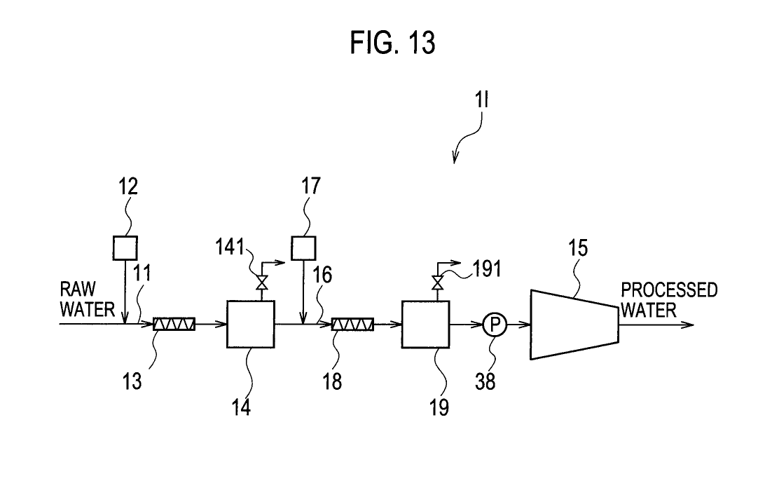

Referring to FIG. 13, according to a twelfth embodiment of the present invention, there is a solid separation system 1l different from the solid separation system 1b according to the second embodiment described with reference to FIG. 3, in that the raw water pump 10 in the latter 1b is substituted by a water pump 38 installed on a water line interconnecting a second flocculation vessel 19 and a centrifugal separator 15 in the former 1l. Raw water is allowed to travel from an unshown raw water tank or water source, through the second flocculation vessel 19, to the pump 38, where it is pumped, so raw water is sent with energy of delivered water currents to the centrifugal separator 15.

In the solid separation system 1b, the raw water pump 10 has a pumped head to send raw water up to the centrifugal separator 15 as a final stage, through associated system elements, so these elements are subject to higher apparent pressures than a necessary head at the final stage, each element being required to have corresponding pressure tightness. To the contrary, in the solid separation system 1l, raw water travels through the second flocculation vessel 19 to the pump 38, where it is pumped, which affords to individually regulate water currents upstream and downstream the pump 38, thus allowing for a reduced pump load, as well as reduced pressure tightness at a respective one of elements such as flocculation vessels 14 and 19 in the solid separation system 1l.

According to the twelfth embodiment, the solid separation system 1l is adapted to pump raw water by a water pump 38 downstream the second flocculation vessel 19, allowing for associated elements conforming to reduced pressure tightness.

According to the twelfth embodiment, the solid separation system 1l affords to implement a simplified system with a saved energy and a saved space, allowing for an enhanced efficiency of solid separation, like the solid separation system 1b according to the second embodiment.

What is claimed is:

1. A solid separation system wherein raw water including solids inflows through a raw water pump and whereby raw water is separated into solids and processed water, the solid separation system comprising:
an aggregating agent injector configured for use of water currents the raw water pump has generated, to have flowing raw water undergo injection of an aggregating agent adapted for aggregation of solids in raw water to form flocs;
a first stirrer configured to work, as raw water inflows with the aggregating agent injected therein, for use of water currents thereof to stir inflowing raw water, and cause to outflow;
a flocculation vessel configured to work, as stirred raw water inflows, to have inflowing raw water reside therein to form flocs, and cause to outflow, by using water currents thereof; and
a centrifugal separator configured to work, as raw water inflows with flocs therein, for use of water currents thereof to have inflowing raw water swirl, effecting centrifugal separation thereof into flocs as solids and processed water.

2. A solid separation system wherein raw water including solids inflows through a raw water pump and whereby raw water is separated into solids and processed water, the solid separation system comprising:
an aggregating agent injector configured to inject, into raw water flowing upstream the raw water pump, an aggregating agent adapted for aggregation of solids in raw water to form flocs;
a first stirrer configured for use of water currents the raw water pump has generated, to stir raw water with the aggregating agent injected therein, and cause to outflow;
a flocculation vessel configured to work, as stirred raw water inflows, to have inflowing raw water reside therein to form flocs, and cause to outflow, by using water currents thereof; and
a centrifugal separator configured to work, as raw water inflows with flocs therein, for use of water currents thereof to have inflowing raw water swirl, effecting centrifugal separation thereof into flocs as solids and processed water.

3. The solid separation system according to claim 1, comprising:
an aggregation aid injector configured to inject, into raw water making use of water currents to flow after injection of the aggregating agent, an aggregation aid adapted to harden or enlarge flocs in raw water; and
a second stirrer configured to work, as raw water inflows with the aggregation aid injected therein, for use of water currents thereof to stir inflowing raw water, wherein
the flocculation vessel is adapted to work, as stirred raw water inflows, to have inflowing raw water reside therein to harden or enlarge flocs, and cause to outflow, by using water currents thereof.

4. The solid separation system according to claim 3, wherein the flocculation vessel comprises:
a first flocculation vessel configured to inlet raw water after a stir thereof with the aggregating agent in the first stirrer; and
a second flocculation vessel configured to inlet raw water after a stir thereof with the aggregation aid in the second stirrer.

5. The solid separation system according to claim 3, comprising a first adjuster injector configured to inject, into raw water before injection of the aggregation aid, an adjuster for pH adjustment of raw water.

6. The solid separation system according to claim 5, comprising:
a first pH meter configured to measure a pH of raw water before injection of the aggregation aid or after injection of the aggregation aid; and
a first pH controller configured to control a dose of the adjuster to be injected by the first adjuster injector in accordance with a measure of pH at the first pH meter.

7. The solid separation system according to claim 1, comprising:
a streaming current meter configured to measure a streaming current of raw water before injection of the aggregating agent or after injection of the aggregating agent; and
an aggregating agent controller configured to control a dose of the aggregating agent to be injected by the aggregating agent injector in accordance with a measure of streaming current at the streaming current meter.

8. The solid separation system according to claim 1, wherein the flocculation vessel is adapted to stir raw water therein, making use of water currents thereof.

9. The solid separation system according to claim 4, wherein the first flocculation vessel is adapted to stir raw water by intensities equal to or smaller than a first stirring intensity, and the second flocculation vessel is adapted to stir raw water by intensities equal to or greater than a second stirring intensity.

10. The solid separation system according to claim 1, comprising a kneading mixer provided upstream the centrifugal separator, and configured to work, as raw water inflows with flocs therein, for use of water currents thereof to deprive flocs of moisture to harden, or form flocs in spherical shapes, and cause raw water to outflow to the centrifugal separator.

11. The solid separation system according to claim 4, comprising:
a kneading mixer provided upstream the centrifugal separator, and configured to work, as raw water inflows with flocs therein, for use of water currents thereof to deprive flocs of moisture to harden, or form flocs in spherical shapes, and cause raw water to outflow to the centrifugal separator;
a second adjuster injector configured to inject, into raw water inflowing with flocs therein into the kneading mixer, an adjuster for pH adjustment of raw water;
a second pH meter configured to measure a pH of raw water before injection or after injection of the adjuster by the second adjuster injector; and
a second pH controller configured to control a dose of the adjuster to be injected by the second adjuster injector in accordance with a measure of pH at the second pH meter.

12. The solid separation system according to claim 1, wherein the flocculation vessel comprises at least one of a scum skimming mechanism and a gas venting mechanism.

13. The solid separation system according to claim 8, wherein the flocculation vessel comprises a backwashing mechanism.
